(19) United States
(12) Patent Application Publication
(10) Pub. No.: US 2016/0063010 A1
(43) Pub. Date: Mar. 3, 2016

(54) SYSTEM AND METHOD OF TRACKING EVIDENCE TO ESTABLISH A CHAIN OF CUSTODY AND PREVENT LOSS

(71) Applicant: Tracker Products, LLC, Erlanger, KY (US)

(72) Inventor: Benjamin Townsend, Erlanger, KY (US)

(21) Appl. No.: 14/473,502

(22) Filed: Aug. 29, 2014

(51) Int. Cl. G06F 17/30; G06Q 50/26; G06Q 50/18

(52) U.S. Cl. CPC G06F 17/3087; G06F 17/30867; G06Q 50/18; G06Q 50/26

(57) ABSTRACT

The present invention is a system and method for tracking evidence objects and sharing evidence data between agencies. The system and method may also record evidence object locations and the agency or persons responsible for the evidence objects in order to build or maintain a chain of custody record for an evidence object.

### TECHNICAL FIELD

Exemplary embodiments of the present invention relate generally to tracking the location and party responsible for evidence collected by investigatory agencies.

### BACKGROUND AND SUMMARY OF THE INVENTION

Evidence collected by law enforcement and other investigatory agencies may comprise many different forms. The forms that evidence may take are almost limitless, a partial list of such forms may include physical evidence, electronic evidence, photographic evidence, audio evidence, and written documents such as reference materials, records, transcribed testimony, letters, and literature.

In some circumstances the amount of evidence collected for an investigation can amount to hundreds of items. Tracking evidence may present many challenges, particularly when the evidence consists of large numbers of items, large items, dangerous, illegal, perishable, or valuable items. One such challenge is the number of different entities and organizations which may require access to the evidence over the course of an investigation and possible legal proceedings that may result if the investigation uncovers illegal activity. Frequently, evidence may be required by police departments, crime laboratories, prosecutors, and defense attorneys. In addition, pieces of evidence may have connections to multiple investigations and resultant legal proceedings. As may quickly become apparent, the number of individuals and organizations that may require access to an item of evidence may be extremely large.

Another challenge is related to the number of parties who may have access to an item of evidence. In order to be used in an investigation and subsequent legal proceedings, an item of evidence may often require the creation and maintenance of a detailed chain of custody. Frequently such detail includes each party who had custody of an item of evidence from the time that it was collected until the time that it is used in a legal proceeding. The requirement to store evidence and related data may extend over the course of several different legal proceedings and may require many months of custody data.

Another significant challenge is the loss of evidence. During the investigation and prosecution stages of a criminal or civil proceeding, a piece of evidence may travel from one agency to another. During transportation and storage, it is not unusual for such evidence to be temporarily or permanently misplaced or damaged. Missing or damaged evidence, as well as evidence that does not have a proper chain or custody may result in an unsuccessful investigation or prosecution.

What is needed is a system and method for tracking evidence that allows parties needing access to an item of evidence to document an items movement from one party or agency to another to create an accurate chain of custody. This tracking system and method should be able to track and locate an item without having to return the item to a central location in order to document the item's next location.

In an embodiment of the invention, an electronic database may be formed using computing devices where such devices may be located remotely from each party or agency that requires access to an item of evidence. The remotely located computer devices may be actual computer devices such as computer servers or may be virtual computers configured using cloud computing techniques. Access to the electronic database may be enabled through the use of computerized devices located at the location of a party or agency requiring access via the internet or other wide area network connection to the remotely located computing devices. In certain embodiments of the invention, portable computing devices may be used to access and update the electronic database. Embodiments of the invention may use application program interfaces to enable access to the electronic database. To identify physical pieces of evidence, embodiments of the invention may use machine readable indicators that may be affixed or otherwise associated with each piece of evidence. These machine readable indicators may be used to identify evidence as it is entered into the database and also to facilitate the check-out of evidence from one location and the subsequent check-in at a second location. These machine readable indicators may provide a convenient way to positively identify an item of evidence and may be read using readers that are in electronic communication with computerized devices located at the various agencies and evidence storage locations where the items of evidence are transferred.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a diagram of an embodiment of the invention;

FIG. 2 is an illustration of data entry fields in an embodiment of the invention;

FIG. 3 is an illustration of the use of globally unique identifiers according to an embodiment of the invention;

FIG. 4 is an illustration of an exemplary data entry according to an embodiment of the invention;

FIG. 5 is a flow chart of the evidence tracking process according to an embodiment of the invention;

FIG. 6 is an illustration of an embodiment of the invention in which a chain of custody report is displayed in a user interface;

FIG. 7 is a graphic diagram of a shared evidence repository database receiving data from an agency evidence database in an embodiment of the invention;

FIG. 8 is a flow chart of the evidence tracking process including a person transporting evidence from a first to a second location according to an embodiment of the invention;

FIG. 9 is a graphic illustration of a synchronization process used in an embodiment of the invention;

FIG. 10 is a graphic illustration of a synchronization process used in an embodiment of the invention, including a portion of data not synchronized with the shared evidence repository database;

FIG. 11 is a diagram of an alternate embodiment of the invention; and

FIG. 12 is a diagram of a synchronization process between two agency evidence databases.

### DETAILED DESCRIPTION OF EXEMPLARY EMBODIMENTS

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

### System Overview

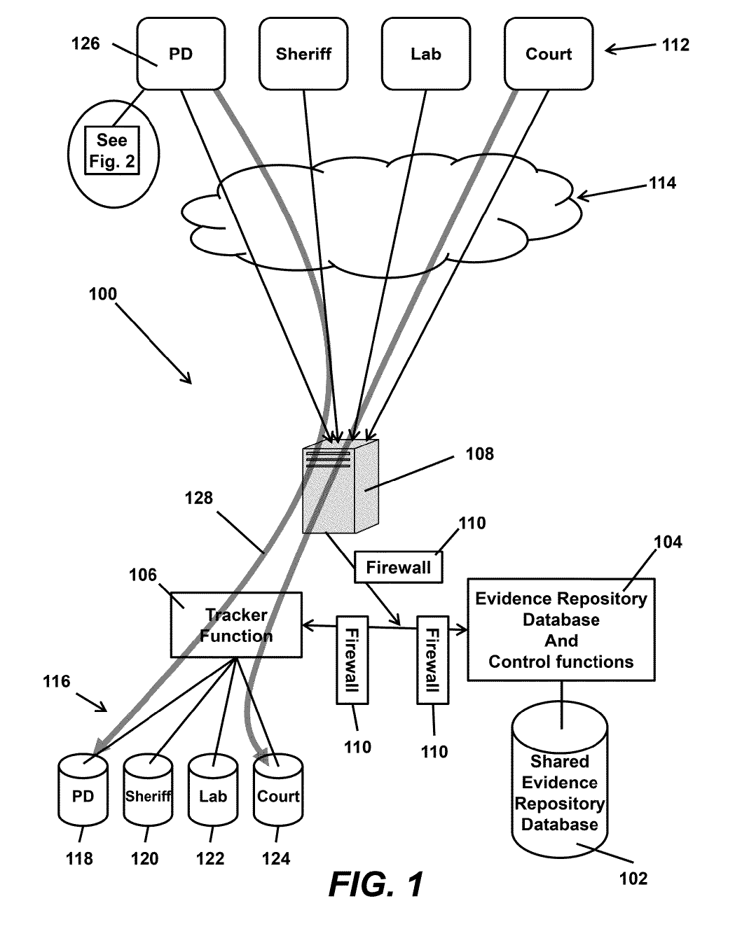

An example evidence tracking system according to an embodiment of the invention is illustrated in FIG. 1. As is shown, in an embodiment of the invention, an evidence tracking system 100 may comprise a shared evidence repository database 102, administrative and control functions 104, and an evidence tracker control function 106 in electronic communication with the administrative and control functions of the shared evidence repository database. The administrative and control functions of the evidence tracker control function 106 and the shared evidence repository database and control functions 104 may be performed using a computer system 108 that may be an actual computer server or may be configured virtually using cloud computing techniques. In order to utilize a cloud computing implementation, application program interfaces (APIs) may be used to access the shared evidence repository database 102 and also the evidence tracker function 106. As is illustrated, various agencies 112 may interact with the evidence tracking system 100. These agencies may connect to embodiments of the invention using the internet 114 or other network technologies. Agencies 112 may communicate to the evidence tracker function 106 via the use of APIs. In such an embodiment, an individual agency may execute a software program on a computing device at the agency to interface with the evidence tracker function 106 or, in certain embodiments, may connect via a web page interface. Agencies may connect via the evidence tracker function 106 to agency evidence databases 116 that are in communication with the evidence tracker function. As is illustrated, in an embodiment of the invention, each agency may have a corresponding agency evidence database. Agency evidence databases may be fully or partially synchronized with the shared evidence repository database 102. As will be described in greater detail herein, an evidence entry from one agency that is applicable to another agency may be shared between more than one agency via storage of the evidence entry in the shared evidence repository database 102 and retrieval into an agency evidence database 116 associated with the agency wishing access to the data. Embodiments of the invention may also be configured without evidence repository databases 102 where such embodiments maintain evidence entries in the agency evidence databases 116 without storage in a shared evidence repository database 102.

### Firewalls

Because of the potentially sensitive nature of evidence entries and the use of the internet or other computerized network, firewall devices 110 may be used to prevent improper or unauthorized access to the evidence tracker function 106 and its associated evidence databases 116. Firewall devices may also be used to prevent improper or unauthorized access to the shared evidence repository database 102. Because of the virtual nature of the evidence tracker function, its databases, and the shared evidence repository database, such firewall devices 110 may also be used to verify the identity of an evidence tracker function as it attempts to access the shared evidence repository database control functions 104.

In embodiments of the invention, the shared evidence repository database 102 may be configured such that information contained in the database can only be accessed using the evidence tracker function 106 in electronic communication with the database. A shared evidence repository database 102 that comprises a large number of evidence records for a number of agencies and individuals may limit an agency or individual's access to certain records based upon location or authorization for access.

Evidence may be tracked using embodiments of the invention by assigning unique identifiers to each piece of evidence. In order to best understand the invention, it is important to make the distinction between evidence items and records contained in an embodiment of the invention. Many evidence items are comprised of actual physical things. However, certain evidence may be in the form of records, images, sound recordings, software or other forms of evidence that may be stored digitally. It is important to clarify that the records contained in the shared evidence repository database 102 are primarily descriptions, notes, and tracking information. Physical evidence may still be comprised of actual physical items. In an embodiment of the invention, a record stored by an embodiment of the invention may describe the evidence, provide a chain of custody history of the evidence, and identify the current location of evidence items.

### Identifiers

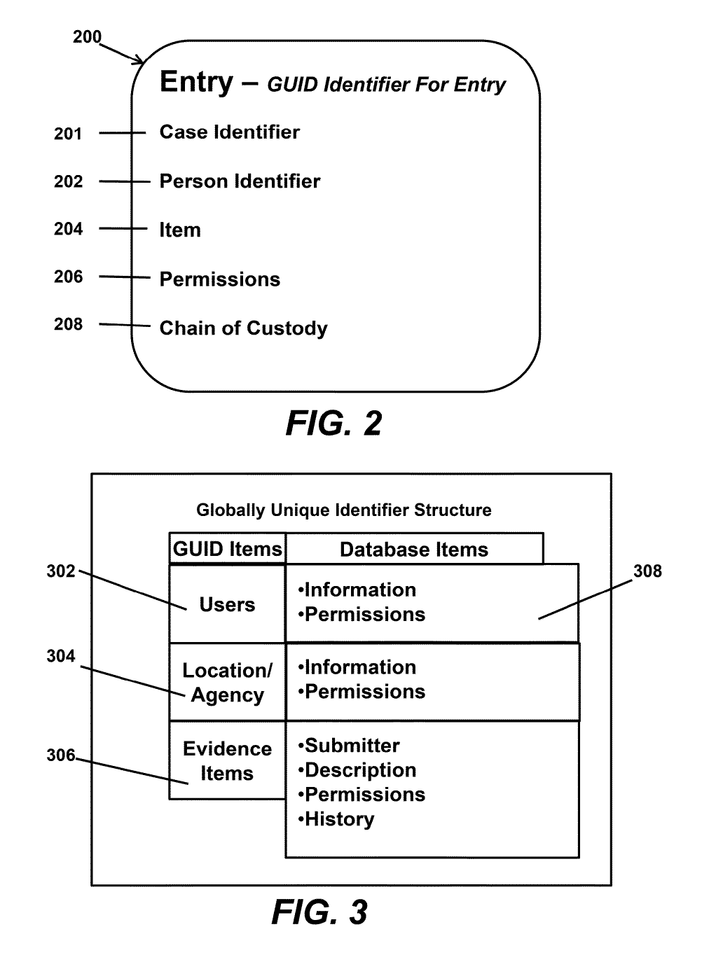

In order to organize evidence, embodiments of the invention may utilize a system of globally unique identifiers (GUIDs). Such identifiers may be formed from strings of numeric or alphanumeric characters such that the number of unique identifiers may be large enough that identifiers need not be repeated when using embodiments of the invention. The identifier structure may be configured to permit users, locations, and evidence items to have unique identifiers. For example, as illustrated in FIG. 3, each user 302, location or agency 304, and evidence item 306 may be assigned an identifier to permit embodiments of the invention to track information and permissions of each user, agency or location. For example, each GUID identifier that is assigned to a user may have an assigned storage area in a database which houses information about the user/entity including general information and permissions 308. Each identifier that is assigned to a location or agency may have an assigned storage area in the database. These storage areas may house information about the location or agency identified by the identifier. As with the user, such information may comprise a description of the location or agency, contact information, including users that are associated with the location or agency and a list of permissions assigned to that location or agency. Identifiers are also assigned to evidence items 306 to be tracked by the system. As with users and locations or agencies, these identifiers may represent storage locations within the database. As is illustrated in FIG. 2, in an exemplary embodiment of the invention, a database storage entry 200 may comprise information identifying the case 201, the submitter of the evidence 202, a description of the evidence 204, and a list of access permissions 206 that identify those users or locations that have the necessary permission to access evidence information. The database storage location may also identify the physical location of a piece of evidence and the history of the locations and persons responsible for the item of evidence over time in the form of a chain of custody record 208. In an embodiment of the invention, access to an evidence item may be limited by individual users 302 or by location or agency 304 using the permissions stored in the database locations assigned to each individual, agency, or location.

In order to uniquely identify agencies, persons, and objects, embodiments of the invention may assign each a GUID identifier. The number of unique identifiers that may be obtained may allow an evidence tracking system 100 to assign an identifier to things to be tracked without having to be concerned with duplicate identifiers. Referring again to FIG. 2, in addition to person identifier 202 and item identifier 204, which may be assigned GUIDs, certain embodiments of the invention may also comprise storage for additional notes, test results, and links to related evidence entries. In embodiments of the invention, the GUID identifiers may be used by the invention to associate items, agencies, and persons in order to build a chain of custody for an item of evidence.

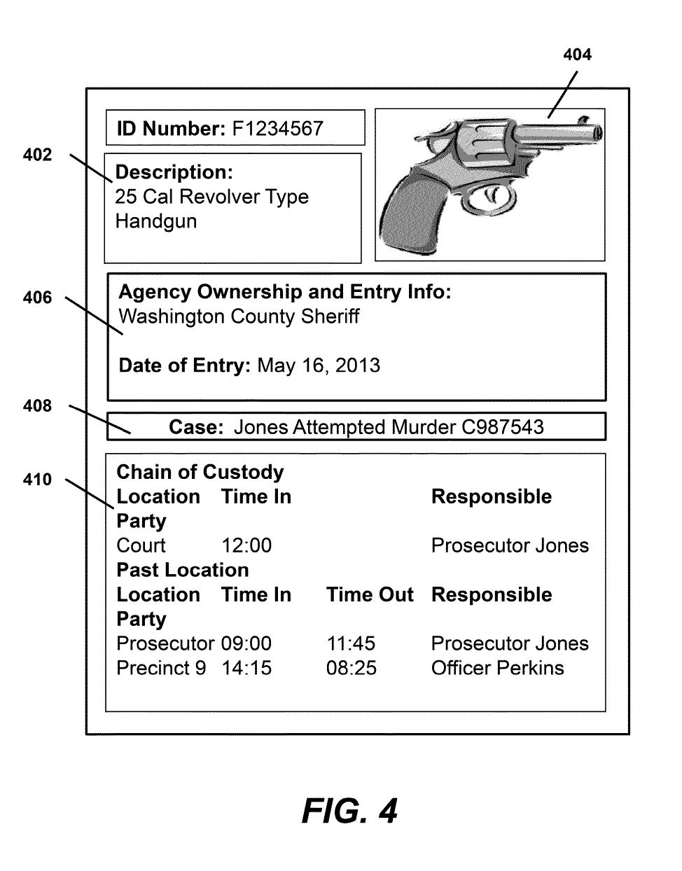

As was previously noted, each evidence database entry may be assigned a GUID by an evidence tracker system. In this manner, each entry may be uniquely identified throughout the evidence tracker system. As was illustrated FIG. 2, an entry into the evidence tracker system may comprise information such as cases, persons, items, permissions, and a chain of custody associated with the entry. FIG. 4 illustrates an example entry for an evidence object. As is illustrated, the entry may comprise a description of the object 402, an image of the object 404, information about the object such as the agency that entered the object into the evidence tracker system 406, a case designation that an agency has assigned to the entry 408, and a chain of custody record 410.

### Chain of Custody

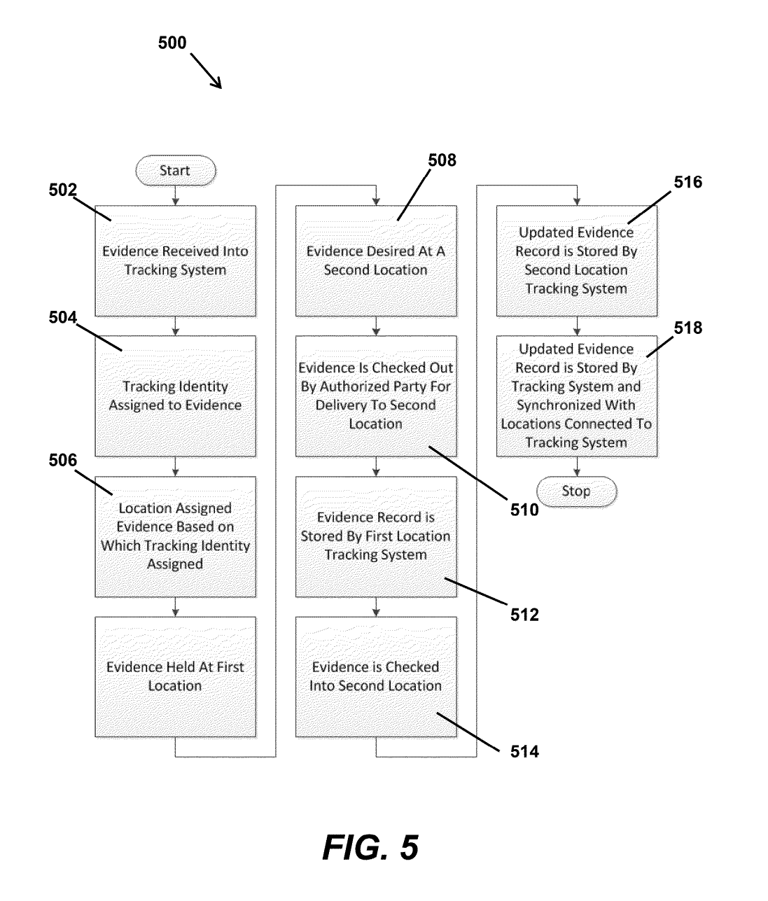

In order to build a chain of custody, embodiments of the invention may be configured to enable agencies, individuals, and other entities that may take possession of an evidence object to enter information about transfers of the evidence object from one location to another. For example, in an embodiment of the invention, a police department 126 may initially create an entry for an evidence object. A flowchart 500 of the steps of entering and transferring an evidence object from one location to another is illustrated in FIG. 5. In step 502, an officer, detective, or other representative of the police department may create an entry for the object in an evidence tracker system 100 to receive the evidence into the tracking system. This entry is illustrated by arrow 128 in FIG. 1. When that entry takes place, a GUID may be assigned by the evidence tracker system in step 504. In embodiments of the invention, access points to the tracker system may be located at locations in which evidence may be referenced or stored. For example, a police station 116 may have an access point that is located at or associated with an evidence storage room. In such an embodiment, when an evidence object is entered into the system and stored in the evidence room, a location may be assigned to the evidence entry in step 506 that indicated the evidence room at the police station is the location starting the chain of custody for that evidence object. The chain of custody may also contain addition information including, but not limited to, information which identifies the operator who entered the evidence object into the system, the date and time of such entry, restrictions, and notes. If the evidence object is desired at a second location 508, an authorized agency or representative of such an agency may check the evidence out for delivery to a second location 510. In embodiments of the invention, the identity of the requesting agency or representative may be recorded along with the intended location to which the evidence object it to be transported. The recorded identity and location data may be stored in step 512. When the evidence object arrives at the intended location, an evidence tracker system associated with that location may check the evidence object into the intended location 514 in the agency evidence database associated with the intended location 516. As is noted in step 518, embodiments of the invention may synchronize the evidence databases 116 with the shared evidence repository database 102 to allow check-out and check-in information to be appended to chain of custody records stored in the evidence database of the initial entry into the tracking system.

In order to maintain the level of detail required in an evidence entry's chain of custody as well as enable an evidence object to be easily located, in some embodiments of the invention, multiple evidence tracker GUIDs may be associated with a single location where such a location has multiple sub-locations in which evidence may be located. For example, a courthouse may be the location but because there may be a plurality of court rooms at the courthouse, each court room may have an evidence tracker GUID location identifier 106 associated with that room. In such an embodiment, a computer device may be located or associated with each sub-location. The computer device may be in electronic communication with a bar code scanner or other means to identify the evidence object and use such a scanner or means to record the arrival and departure of an evidence object to and from a sub-location. As a result, chain of custody data may be configured to include sub-location data. This sub-location data may also be used to allow someone searching for an evidence object to narrow the search down to a sub-location rather than the entire location as may be the case in an embodiment that does not include sub-location evidence object entry and tracking.

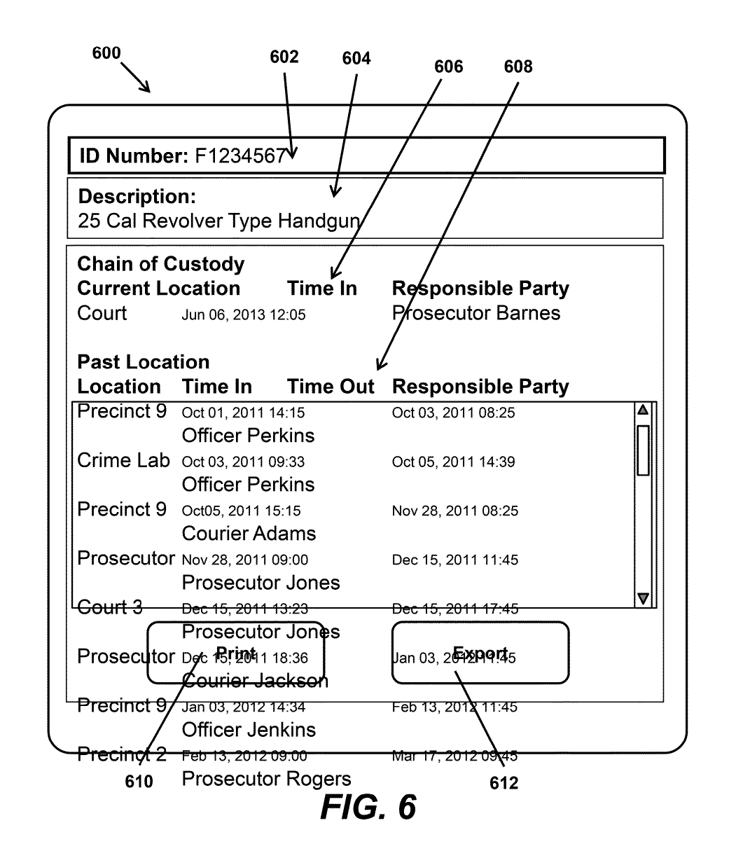

In certain embodiments of the invention, chain of custody data may be displayed, saved, or printed. Chain of custody data may have various uses including, but not limited to, locating an item of evidence or providing information to a court regarding the location of an evidence item from the time that the item was discovered until the chain of custody data was requested or the item of evidence was disposed of. An example embodiment of a chain of custody display 600 is illustrated in FIG. 6. As is shown, such an embodiment may display an identification number 602 and description 604 of an evidence item. In such an embodiment, the current location of an evidence time may be displayed 606. This information may be useful for locating the evidence item should another agency wish to examine the evidence item. In addition to the current location, embodiments of the invention may also display chain of custody information that originates at the time the evidence item was entered into the evidence tracking system. Such a chain of custody display is illustrated at 608. As was noted above, such chain of custody data may be required by the court in order to demonstrate that the evidence has been accounted for from the time that it was discovered until such evidence was presented in a trial or other proceeding in the court. Because a user of the evidence tracker system may wish to create a paper copy of the chain of custody record, embodiments of the invention may provide controls 610 that facilitate printing the chain of custody information. A user may also wish to export chain of custody data for use in the creation of reports or legal documents. Embodiments of the invention may be configured to present export controls 612 to users to facilitate such exports of data.

As was noted above, a chain of custody may also be used to identify the location of an evidence item. For example, if an evidence item was moved from a police department to a courthouse as illustrated in the chain of custody of FIG. 6, an authorized user may access the evidence tracker system to view an evidence item's last location and, using the chain of custody data illustrated, determine that the evidence item is located in the court. As is illustrated at 608, the last location recorded in the chain of custody may be displayed as the then-current location of the evidence item. Because embodiments of the invention may be implemented using remotely located computerized databases, such embodiments may be configured to allow an authorized user to remotely view chain of custody data stored in such databases. Thus, in such embodiments, an authorized user may be able to remotely locate an evidence item without having to make visits or phone calls to several agencies searching for an evidence item as may be required using known methods.

### Machine Readable ID

As was noted previously, evidence may be a physical item that has a unique GUID identifier assigned by an embodiment of the invention. In order to allow users of the invention to associate a physical item with the identifier and corresponding database entry, a machine readable indicator may be affixed to physical evidence items. This affixation may be accomplished by a machine readable tag, a bag enclosing the evidence item, or a sticker attached to the evidence item. Examples of machine readable indicators may be, without limitation, bar codes, human and machine readable serial numbers, or radio frequency identifiers (RFID's). As was noted above, a computerized device may be used at an agency or other evidence location to interface with the evidence tracker system. Such computerized devices may be configured with scanners or other hardware capable of reading the indicators affixed to evidence items. These scanners may be configured to read the indicators and identify the evidence object being scanned. Scanners are preferred because of the decreased likelihood that an identification code may be misread or keyed into the computerized device incorrectly by human operators.

### Tracker API

An evidence tracker control function 106 may be used to interface with the shared evidence repository database 102 as was illustrated in FIG. 1. In an exemplary embodiment of the invention, an evidence tracker control function may comprise one or more agency evidence databases 116 that are allocated to agencies storing and accessing evidence data, and a computerized device that serves as a controller to manage access and synchronize functions. The computerized device may be a computer server or may be a virtual computer. In either case, the computerized device may be configured to have a processor, memory, and storage. In addition, in order to identify evidence, an evidence tracker system may also comprise machine readable indicator scanners and image capture devices such as digital cameras. The machine readable indicator scanner and image capture devices may be located at individual agencies 112 and be in electronic communication with computer devices at those agencies where the computer devices are in electronic communication with the evidence tracker function 106. When used to capture evidence identifying information, these ID readers and image capture devices may be configured using software to communicate ID and image information to the evidence tracker function 106 for storage in a local database. The use of an application program interface (API) may allow for a virtual deployment of embodiments of the invention as illustrated in FIG. 1. In such an embodiment, an application running on a computerized device located at an agency or other location requiring access to the evidence tracking system 100 may perform software instructions that comprise “calling” the API in order to interface with the evidence tracker function 106. In other embodiments, the evidence tracker function may be configured using a web server that presents a web page interface for the evidence tracker function. Such an embodiment may be configured to allow a user to log into a webpage providing evidence entry, management, and tracking functionality to perform the evidence entry and tracking functions described herein. In still other embodiments of the invention, the evidence tracker function may be performed by a computerized device configured by software to interface with one or more evidence databases and exchange data with a shared evidence repository database that may be located remotely from the computerized device.

### Databases

As is illustrated in the example embodiment of the invention shown in FIG. 1, embodiments of the invention may comprise a plurality of databases. As is shown at 118, 120, 122, and 124, evidence databases, which may be referred to individually as agency evidence databases may be configured to store evidence data for agencies using the evidence tracking system 100. An agency evidence database may store data comprising records of the agency's evidence items that were entered using the evidence tracker function of which the agency evidence database is associated. For example, if a handgun was entered into the evidence tracker at a police station, the evidence tracker system's agency evidence database associated with that police station may contain a record of the handgun. Until that record is synchronized with the shared evidence repository database 102, the record of the handgun may only exist on the police department agency evidence database 118. In certain embodiments of the invention, records may be synchronized between two or more agency evidence databases without the requirement that the entry be synchronized with a shared evidence repository database.

In certain embodiments, an agency evidence database 116 may contain records for evidence items that are located in the office or agency associated with the evidence tracker function 106 but which originally were entered into a different agency evidence database. For example, if an evidence item were transferred from another location to the police station, that evidence item's database record may be copied into the agency evidence database 118 associated with the police station while the evidence item is located at the police station. As a result, the evidence item record may be located in the agency evidence database from the other location and at least portions of the evidence item record may also be located in the agency evidence database of the police station. In other embodiments of the invention, certain portions of the records for evidence items contained in the shared evidence repository database 102 may be synchronized with the agency evidence databases for each agency associated with the shared evidence repository database.

### Shared Evidence Repository Database

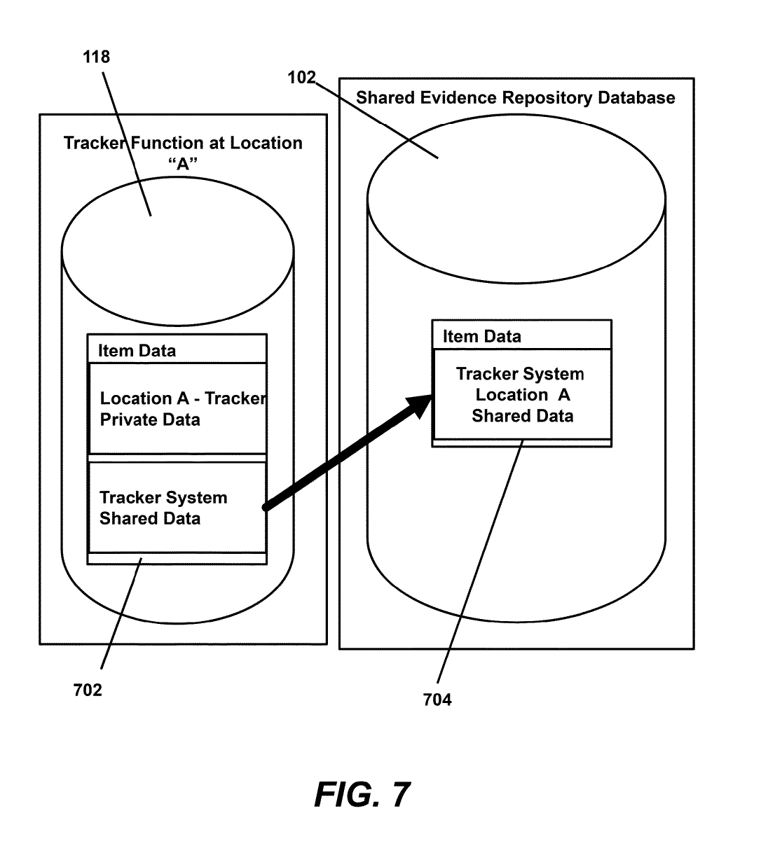

Continuing with the handgun example of FIG. 4, an agency evidence database of the evidence tracker system may synchronize the handgun record in the agency evidence database with the shared evidence repository database 102. As is illustrated in FIG. 7, an evidence record 702 of the handgun may be synchronized between the agency evidence database associated with the police department 118 and the shared evidence repository database 102 to produce a record 704 in the shared evidence repository database. This record may contain the entirety of the information from the agency evidence database 702. Alternatively, portions of the record may be configured to be confidential, resulting in only a portion of the record to be stored in the shared evidence repository database as illustrated in the figure.

As is frequently the case, evidence may be required at a location other than where it was initially stored. In an embodiment of the invention, the evidence tracker system may be configured to indicate restrictions on who may check the evidence out of a storage location. In such embodiments, the evidence tracker system may review any restrictions noted in the record associated with the evidence entry. Examples of such restrictions may include, without limitation, limits imposed on who may take possession of the evidence, limits on what locations or agencies are permitted to take possession of the evidence, and storage restrictions required by the nature of the evidence. To determine if there are such restrictions, an operator may enter the GUID assigned to the party or agency wishing to check the evidence item out of the storage location. In other embodiments, an operator may enter other identifiable information, such as the name or an identification number assigned to the party or agency wishing to check the evidence item out of storage. As part of a checkout process, an operator may scan the machine readable label affixed to the evidence and indicate the new location of the evidence. If a restriction is identified, the evidence tracker system interface used by the operator may display a warning or other notice to inform the operator that there is a restriction on the evidence that may be violated should the evidence be checked out by the requesting party or agency.

If there are no restrictions noted in the evidence record that would prevent a transfer, the evidence may be transferred to the person or agency seeking the evidence. As is illustrated in step 512 of FIG. 5, the change in custody of the evidence may be stored to create or maintain a chain of custody record. When a person or agency delivers the evidence to the new location, a second evidence tracker function may record the receipt of the evidence by scanning an identifier attached to the evidence item. The evidence tracking system may then use the identifier information to locate the GUID number and evidence record associated with the evidence item. Once located, the chain of custody record associated with the evidence item may be updated to reflect the new location and a copy of the evidence record data may be synchronized to the agency evidence database associated with the evidence tracker function of the new location.

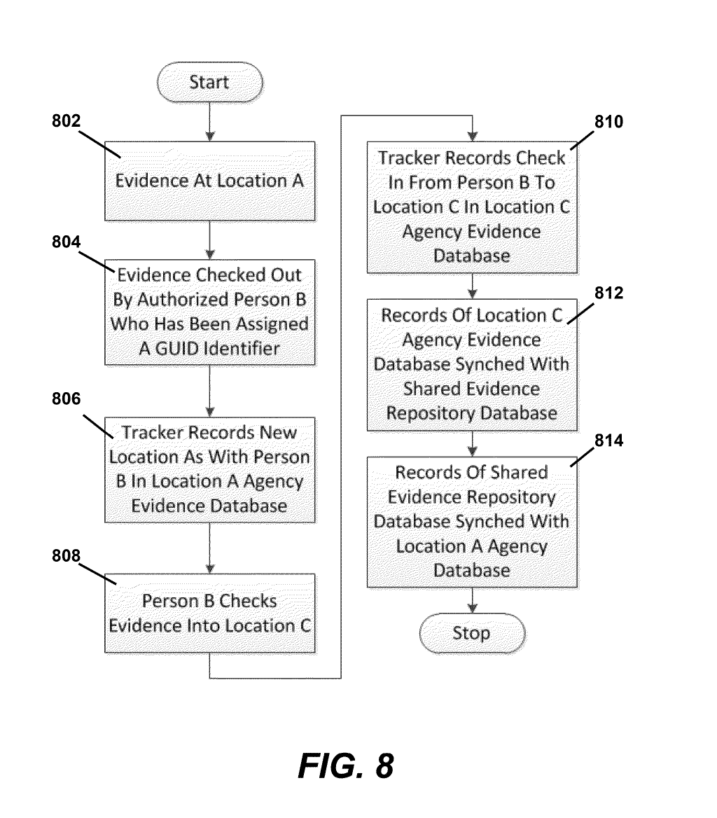

Certain embodiments of the invention may identify the party or agency checking the evidence out of its previous storage location as an interim location for the evidence. An example of such an embodiment is illustrated in FIG. 8. As is shown, the evidence tracker may record a first storage location as, for example, a police station in step 802, in the illustrated example, an authorized person who has been assigned a GUID identifier may check out the evidence item in step 804. As the evidence item is checked out, the evidence tracker function may record a new storage location as the authorized person in the agency evidence database of the first location in step 806. In step 808, the authorized person may check the evidence item into the evidence tracker function associated with a new location, for example, a courthouse. The evidence tracker function of the courthouse may record the check in of the evidence from the authorized person to the courthouse in the agency evidence database associated with the courthouse 810. In some embodiments of the invention, the new location data may be synchronized with the shared evidence repository database 812, and then in step 814 the evidence entry indicating the new evidence location as the courthouse may be synchronized to the agency evidence database associated with the police station. The synchronization between the shared evidence repository database and the various agency evidence databases may allow a user wishing to locate the evidence to quickly identify the current location of the evidence.

### Viewing Restrictions

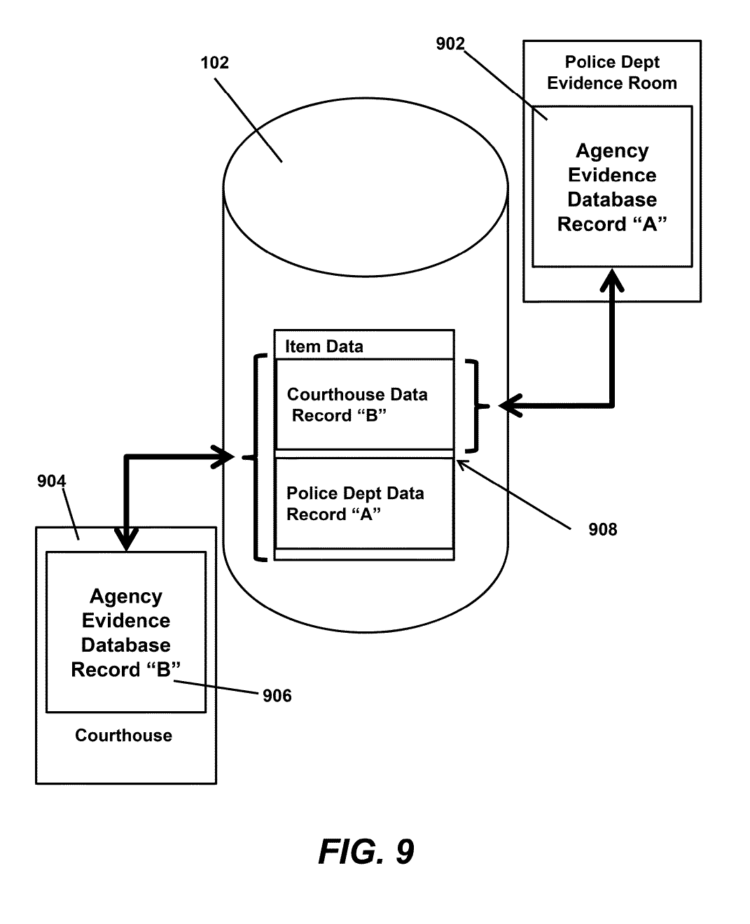

In certain embodiments of the invention, evidence item information may be restricted from viewing or synchronization. FIG. 9 illustrates an embodiment of the invention in which certain evidence information is not synchronized with one or more agency evidence databases to preserve the confidential nature of certain evidence data. As is illustrated, an evidence tracker system may synchronize police department evidence data record “A” 902 with the shared evidence repository database 102. As illustrated, a second agency evidence database 904 associated with a courthouse may have synchronized evidence data record “B” 906 with the shared evidence repository database 102. As is shown at 908, evidence records may be synchronized between the agency evidence database associated with the police department and the shared evidence repository database. The agency evidence database 904 associated with the courthouse may have additional information 906 that is synchronized with the shared evidence repository database but in this illustration, not shared with the police department. The embodiment of the invention shown in the figure illustrates how the restriction of certain evidence may prevent the disclosure of that evidence to other agencies.

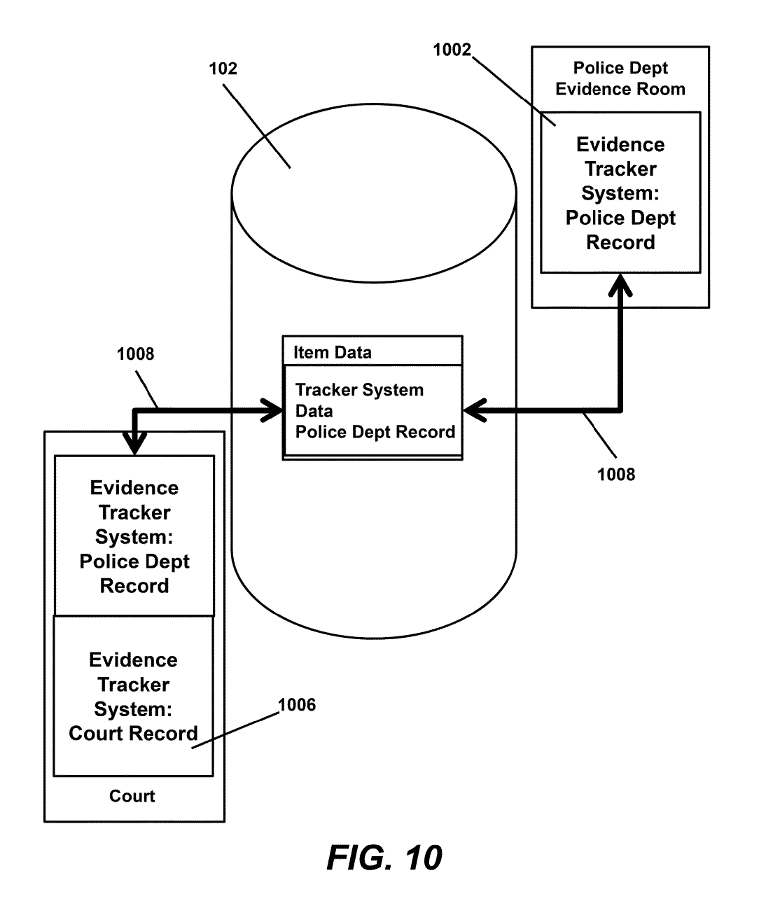

In other embodiments of the invention, evidence information synchronization may be restricted to an agency evidence database and not synchronized to the shared evidence repository database 102. As is illustrated in FIG. 10, an evidence tracker system may synchronize evidence records of the police department 1002 with the shared evidence repository database 102 but not synchronize evidence records of the courthouse 1006. In an embodiment that is configured to restrict synchronization of private or sensitive data, only the shared evidence record data may be synchronized as is illustrated by the arrows 1008. The courthouse evidence record data 1006 is not synchronized in the illustrated embodiment. The result is that the courthouse evidence record data is restricted to the agency evidence database associated with the courthouse.

In other embodiments of the invention, users of an evidence tracker system may be assigned permission levels that prevent certain users from accessing, viewing, or modifying certain evidence data records. Such an embodiment may be used to avoid disclosure of sensitive evidence information.

### Virtual Agency Evidence Databases

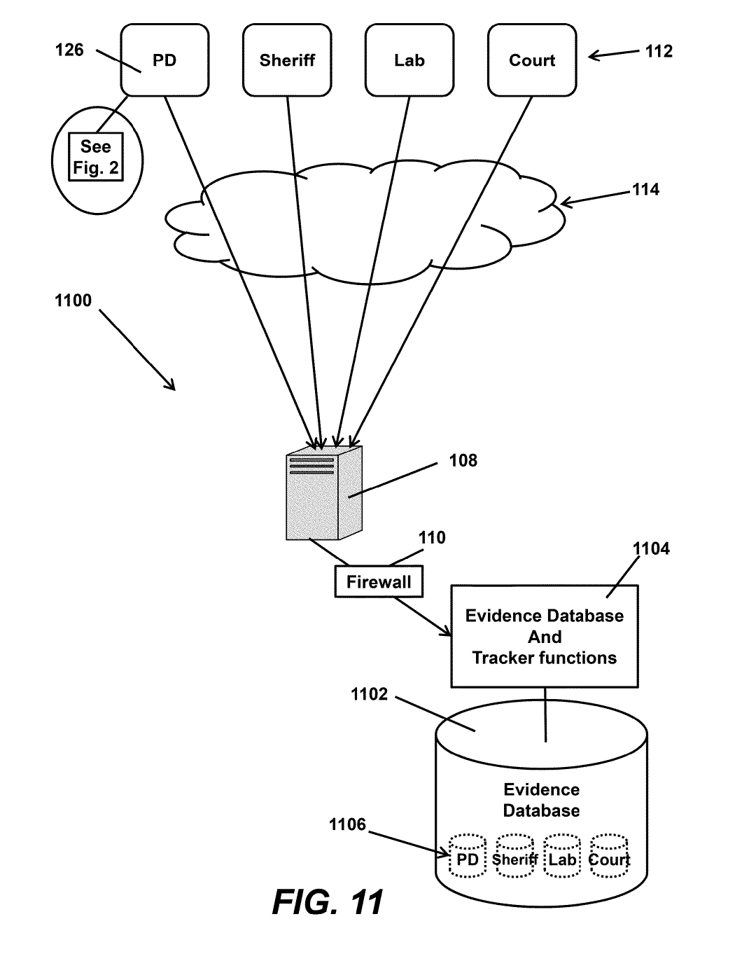

As was illustrated in FIG. 1, embodiments of the invention may be configured to comprise a shared evidence repository database 102 and a plurality of agency evidence databases 116. In another embodiment, the agency evidence databases may be formed virtually within an evidence database. Such an embodiment is illustrated in FIG. 11 as 1100. As is shown, an evidence database 1102 may be located remotely from the various agencies 112. As with the embodiment illustrated in FIG. 1, agencies may access the database via a wide area network such as the internet 114. A computer server 108 may be configured from an actual computer server device or may be formed virtually using cloud computing techniques. In some embodiments a firewall 110 may be used to control access to the evidence database. Evidence database and tracker functions 1104 may be performed using the computer server 108.

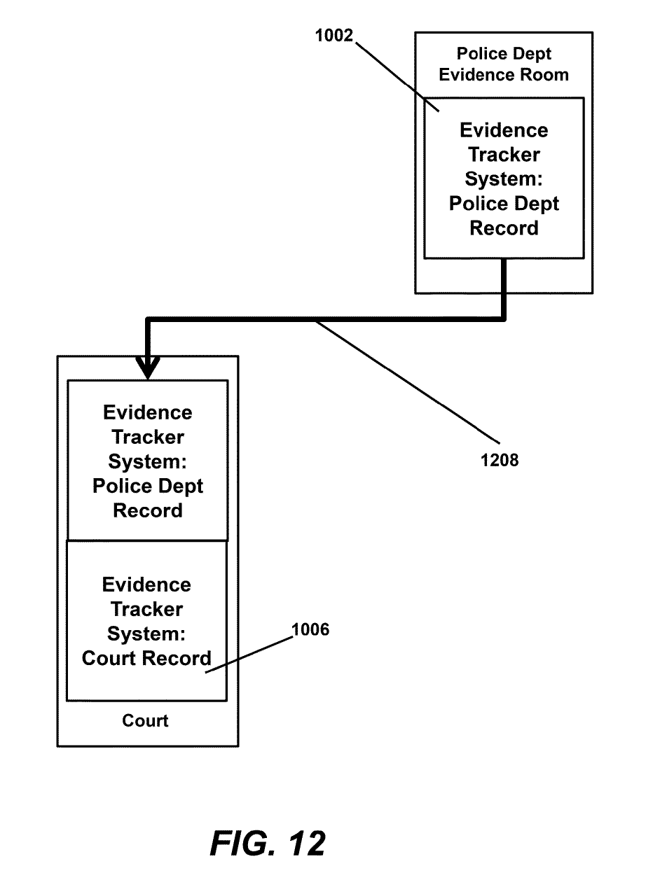

As is illustrated at 1106, various agency databases may be formed virtually in the evidence database 1102. As with the embodiment illustrated in FIG. 1, evidence may be shared from one virtual agency database to another. Because there is no shared evidence repository database in the embodiment of FIG. 11, evidence may be synchronized between the agency databases in a manner similar to what is illustrated in FIGS. 7, 9, and 10 with the difference being that there is no shared evidence repository database 102. As an example, FIG. 12 represents the synchronization similar to that illustrated in FIG. 10 without the intermediary shared evidence repository database 102. As is illustrated, the police department record 1002 may be shared directly 1208 with the court. However, because the court has chosen not to share records with the police department, the court record 1006 is not synchronized with the police department. Because the agency databases may be formed virtually within the evidence database 1102, the management of the synchronization process may be performed by the evidence database and tracker functions 1104. This embodiment may have management and maintenance advantages over the embodiment of FIG. 1 as the result of having a single database rather than the shared evidence repository database 102 and a plurality of agency evidence databases 116.

### Appending Information to an Evidence Item

As was noted earlier, evidence data records may comprise chain of custody data, evidence images and descriptions, access permissions, and a record of the user that created the evidence data record when the evidence was initially entered in an embodiment of the invention. In an embodiment of the invention, the user or agency that created the evidence record may also add additional data to that record. An example of such additional data may be, without limitation, test results in the event that the evidence was subjected to various forms of testing, comments to explain changes in the condition of the evidence, comments with regard to testimony associated with the evidence, or an estimate of the monetary value or authenticity of a piece of evidence as the result of an appraisal. Such a configuration may allow an agency to share evidence data through synchronization without having to worry that the evidence records created by that agency will be corrupted by the data of another agency.

Removing Items from the Shared Evidence Repository Database

In some circumstances, evidence may no longer be required to be held. For example, if the evidence was property of one of the parties to a dispute or criminal proceeding, the evidence may be returned to its owner at the conclusion of legal proceedings. In order to accommodate such circumstances, certain embodiments of the invention may be configured to allow an evidence data record to be removed from the one or more databases in which the evidence record data may have been recorded as the result of a synchronization process. Such removal may be accomplished by completely deleting the evidence data record from the databases, or in certain embodiments, the chain of custody may be appended to include an entry indicating that the evidence has been returned to the individual or organization from which it was originally obtained.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A computerized evidence tracking system, comprising:
at least one computer network database for storing information data records about a plurality of evidence objects, wherein each evidence object information data record includes a unique identifier;
said network database is configured to receive evidence object information data from a plurality of remote evidence object locations, via computer network connections to said at least one network database;
a computerized device comprising a processor in communication with said at least one computer network database, which executes software instructions to:
receive requests from a plurality of operators in a plurality of remote locations to locate an evidence object;
retrieve evidence object information, for the evidence object to be located, from said computer network database; and
provide evidence object location contained in the retrieved evidence object information to the operator.

2. The computerized method of claim 1, further comprising software instructions which cause the processor to:
assigning a unique identifier to a transfer agent used to transfer an evidence object from a first location to a second location; and
store in an evidence object data point at the computer network database, a time representing the transfer of the evidence object from the first location to the transfer agent, and the identity of the second location.

3. The computerized system of claim 1, further comprising:
an input device for receiving machine readable code data from identification tags affixed to an evidence object, in communication with the computerized device; and
software instructions that cause the processor to receive a machine readable code data from the input device, and store the code data in the information data record for the evidence object.

4. The computerized system of claim 1, further comprising software instructions that cause the processor to:
receive an evidence object description;
assign a unique identifier to the evidence object described by the received evidence object description; and
store the received evidence object description and unique identifier in an evidence object information data record of at least one database.

5. The computerized system of claim 4, where the evidence object description comprises the time the evidence object description was stored.

6. The computerized system of claim 4, where the evidence object description comprises an image of the evidence object.

7. The computerized system of claim 4, further comprising software instructions that cause the processor to:
receive a request to remove an evidence object from a first location for transport to a second location;
receive a unique identifier identifying the evidence object to be removed from the first location; and
store the received request, the unique identifier, and the time the evidence object was removed in the information data record for the evidence object.

8. The computerized system of claim 7, further comprising software instructions that cause the processor to:
receive a request to add an evidence object to a location;
receive a unique identifier identifying the evidence object to be added to the location; and
store the received request, the unique identifier, and the time the evidence object was added in the information data record for the evidence object.

9. A computerized evidence tracking system, comprising:
at least one computer network database for storing information data records about a plurality of evidence objects, wherein each evidence object information data record includes a unique identifier;
said network database is configured to receive evidence object information data from a plurality of remote evidence object locations, via computer network connections to said at least one network database;
a computerized device comprising a processor in communication with said at least one computer network database, which executes software instructions to:
receive a request from an operator for a chain of custody report for an evidence object;
retrieve evidence object information comprising evidence object location data for the evidence object from said computer network database; and
provide an evidence object chain of custody report comprising evidence object location data for each location where said evidence object has been from the time the evidence object data was first entered into said at least one database through the time said evidence object data is retrieved.

10. The computerized method of claim 9, further comprising software instructions which cause the processor to:
assigning a unique identifier to a transfer agent used to transfer an evidence object from a first location to a second location; and
store in an evidence object data point at the computer network database, a time representing the transfer of the evidence object from the first location to the transfer agent, and the identity of the second location.

11. The computerized system of claim 9, further comprising:
an input device for receiving machine readable code data from identification tags affixed to an evidence object, in communication with the computerized device; and
software instructions that cause the processor to receive a machine readable code data from the input device, and store the code data in the information data record for the evidence object.

12. The computerized system of claim 9, further comprising software instructions that cause the processor to:
receive an evidence object description;
assign a unique identifier to the evidence object described by the received evidence object description; and
store the received evidence object description and unique identifier in an evidence object information data record of at least one database.

13. The computerized system of claim 12, where the evidence object description comprises the time the evidence object description was stored.

14. The computerized system of claim 12, where the evidence object description comprises an image of the evidence object.

15. The computerized system of claim 12, further comprising software instructions that cause the processor to:
receive a request to remove an evidence object from a first location for transport to a second location;
receive a unique identifier identifying the evidence object to be removed from the first location; and
store the received request, the unique identifier, and the time the evidence object was removed in the information data record for the evidence object.

16. The computerized system of claim 15, further comprising software instructions that cause the processor to:
receive a request to add an evidence object to a location;
receive a unique identifier identifying the evidence object to be added to the location; and
store the received request, the unique identifier, and the time the evidence object was added in the information data record for the evidence object.

17. A computerized method of evidence tracking comprising the steps of:
receiving at a computer network database for storing information data records about a plurality of evidence objects, evidence object information data from a plurality of remote object locations, such data records comprising the locations of the evidence objects;
assigning a unique identifier to each evidence object;
analyzing the information data for a selected evidence object; and
generating a report comprising the most recent location of the selected evidence object.

18. The computerized method of claim 17, further comprising the steps of:
receiving at the computer network database, evidence object data from a remote location, such data comprising an evidence object identifier, and a time associated with the receiving of such data, storing the received data in an information data record; and
generating a chain of custody report comprising a list of received object location data and times associated with the receipt of each object location data for the selected evidence object.

19. The computerized method of claim 17, further comprising the steps of:
receiving a machine readable code from a remotely located reading device where such code is affixed to an evidence object; and
storing in an evidence object data record for the evidence object, located at the computer network database, the received code.

20. The computerized method of claim 17, further comprising the steps of:
assigning a unique identifier to a transfer agent used to transfer an evidence object from a first location to a second location; and
storing in an evidence object data point at the computer network database, a time representing the transfer of the evidence object from the first location to the transfer agent and the identity of the second location.
